(19) United States
(12) Patent Application Publication
(10) Pub. No.: US 2020/0154917 A1
(43) Pub. Date: May 21, 2020

(54) ENVIRONMENTALLY-FRIENDLY STRAW IMPROVED STRUCTURE

(71) Applicants: YING-CHE KAO, Chiayi County (TW); YA-TING KAO, Chiayi County (TW)

(72) Inventors: YING-CHE KAO, Chiayi County (TW); YA-TING KAO, Chiayi County (TW)

(21) Appl. No.: 16/194,331

(22) Filed: Nov. 17, 2018

(51) Int. Cl. A47G 21/18; F16B 2/22

(52) U.S. Cl. CPC A47G 21/18; F16B 2/22

(57) ABSTRACT

An environmentally-friendly straw improved structure comprises a tube, at least one joint portion, and at least one combination portion. The tube is curlily formed by a sheet-like flexible member, the flexible member has an upper surface and a lower surface, a first side edge and a second side edge are respectively formed at two sides of the upper surface, and a third side edge and a fourth side edge are respectively formed at two sides of the lower surface. A hollow portion is correspondingly formed inside the tube. The joint portion is correspondingly formed at the first side edge of the upper surface. The combination portion is correspondingly formed at the fourth side edge of the lower surface. The combination portion is snapped with the joint portion to form the hollow portion for a fluid to pass through.

### BACKGROUND OF THE INVENTION

### Field of Invention

The present invention relates to an environmentally-friendly straw improved structure, and more particularly to an environmentally-friendly straw improved structure that is reusable, environmentally effective and thoroughly cleanable.

### Related Art

With the popularity of tea drinking culture, consumers usually buy a cup of tea when they dine. Among them, the bubble or boba milk tea is made by adding and mixing tea with springy mouthfeel and chewy tapioca balls (or pearls), which is more popular among consumers. There are also drinks such as green tea, flower tea and juices added with tapioca balls. When buying these beverages, the store will provide a plastic straw for the consumer to suck the beverage. If the beverage is acidic, it is easy for the plastic straw to dissolve toxic and cause harm to human health. Both disposable chopsticks and plastic straws are disposable products that can only be used one time and are discarded after use. Disposable chopsticks and plastic straws will generate a large amount of garbage and cause environmental problems.

As consumers become more aware of their personal health and environmental protection, many consumers have their own reusable environmentally-friendly tableware when they dine outside. But with all kinds of environmentally-friendly tableware, it is quite inconvenient to carry, use and store, so that the consumers are often in the dilemma of choosing between health, environmental protection and convenience of use. Often, because of the lack of convenient storage and use of environmentally-friendly tableware, they cannot be used continuously, so that it is still practically difficult to reduce the usage amount of plastic straws effectively.

### SUMMARY OF THE INVENTION

Therefore, in order to effectively solve the above problems, a main object of the present invention is to provide a reusable environmentally-friendly straw improved structure.

A secondary object of the present invention is to provide an environmentally-friendly straw improved structure that is environmentally effective.

Another secondary object of the present invention is to provide an environmentally-friendly straw improved structure that can be thoroughly cleaned without residual dirt.

In order to achieve the above objects, the present invention provides an environmentally-friendly straw improved structure comprising a tube, at least one joint portion, and at least one combination portion. The tube is curlily formed by a sheet-like flexible member, the flexible member has an upper surface and a lower surface, a first side edge and a second side edge are respectively formed at two sides of the upper surface, and a third side edge and a fourth side edge are respectively formed at two sides of the lower surface. A hollow portion is correspondingly formed inside the tube. The joint portion is correspondingly formed at the first side edge of the upper surface. The combination portion is correspondingly formed at the fourth side edge of the lower surface. The combination portion is snapped with the joint portion to form the hollow portion for a fluid to pass through.

With the design of the structure of the present invention, the joint portion formed at the first side edge of the upper surface and the combination portion formed at the fourth side edge of the lower surface are assembled and fastened with each other, so that the original sheet-like flexible member is curled to form the tube. Thus, the user can use the tube to suck the fluid (the fluid refers to beverages, tapioca balls, pearls, coconut jelly, etc.). When the tube needs to be cleaned after use, it is only required to detach the joint portion and the combination portion to return the tube to the sheet-like flexible member, and then directly wash and clean the flexible member with water to have the tube thoroughly cleaned, thereby achieving the effect of preventing dirt from remaining in the tube.

### BRIEF DESCRIPTION OF THE DRAWINGS

FIG. 1 is an exploded view of a first embodiment of an environmentally-friendly straw improved structure of the present invention;

FIG. 2 is a perspective view of the first embodiment of the environmentally-friendly straw improved structure of the present invention;

FIG. 3 is a combination view of the first embodiment of the environmentally-friendly straw improved structure of the present invention;

FIG. 4 is an exploded view of a second embodiment of the environmentally-friendly straw improved structure of the present invention;

FIG. 5 is a perspective view of a third embodiment of the environmentally-friendly straw improved structure of the present invention;

FIG. 6 is a schematic view of the implementation of the first embodiment of the environmentally-friendly straw improved structure of the present invention; and

FIG. 7 is an exploded view of a fourth embodiment of the environmentally-friendly straw improved structure of the present invention.

### DETAILED DESCRIPTION OF THE INVENTION

The above objects of the present invention, as well as its structural and functional features, will be described in accordance with the preferred embodiments of the accompanying drawings.

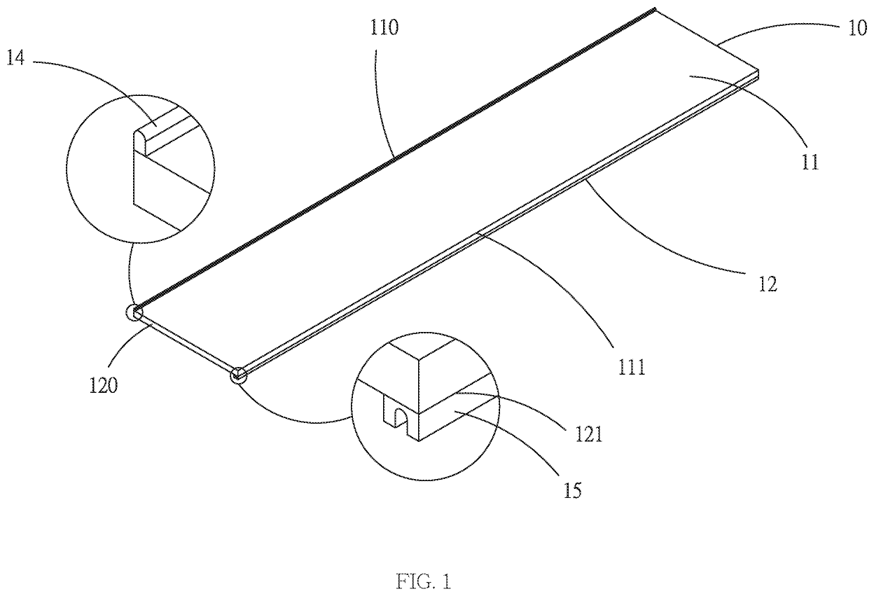

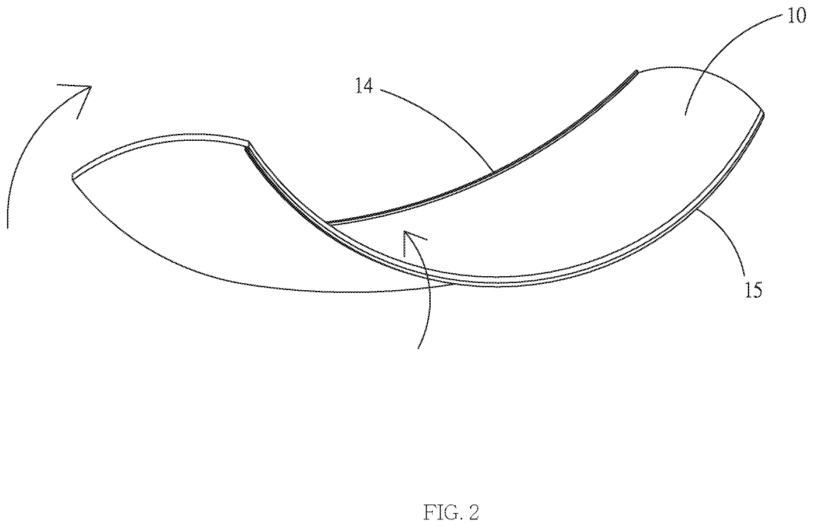

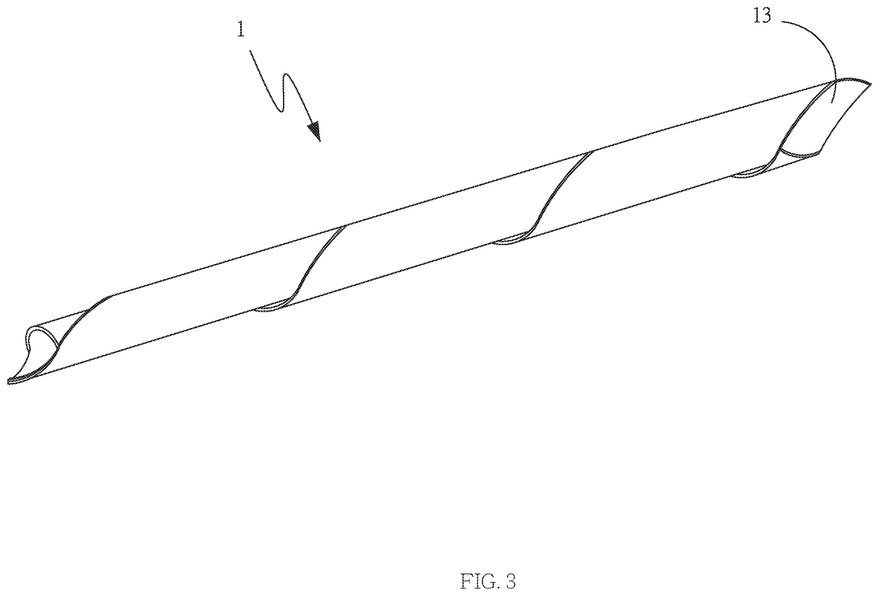

Please refer to FIGS. 1, 2 and 3 respectively for the exploded view, perspective view and combination view of the first embodiment of the environmentally-friendly straw improved structure of the present invention. As shown in the figures, the environmentally-friendly straw improved structure includes a tube 1, at least one joint portion 14, and at least one combination portion 15. The tube 1 is curlily formed by a sheet-like flexible member 10, the flexible member 10 has an upper surface 11 and a lower surface 12, a first side edge 110 and a second side edge 111 are respectively formed at two sides of the upper surface 11, and a third side edge 120 and a fourth side edge 121 are respectively formed at two sides of the lower surface 12. The first side edge 110 corresponds to the third side edge 120, the second side edge 111 corresponds to the fourth side edge 121, and a hollow portion 13 is correspondingly formed inside the tube 1.

The joint portion 14 is correspondingly formed at the first side edge 110 of the upper surface 11, and the combination portion 15 is correspondingly formed at the fourth side edge 121 of the lower surface 12. In this embodiment, the joint portion 14 is illustrated by a rib, and the combination portion 15 is illustrated by a groove. The rib and the groove can be respectively formed in a continuous or discontinuous manner at the first side edge 110 of the upper surface 11 and the fourth side edge 121 of the lower surface 12, and the rib is correspondingly snapped and assembled with the groove to form the hollow portion 13 for a fluid (the fluid refers to beverages, tapioca balls, pearls, coconut jelly, etc.) to pass through. It should be noted that the combination portion 15 is spaced apart from a foremost end of the tube 1 by a distance and then fastened and assembled with the joint portion 14, and a cross-sectional area of two ends of the assembled tube 1 will form a beveled surface to cause the two ends of the tube 1 to be respectively formed as a tip end.

In addition, it should be noted that the sheet-like flexible member 10 is made of any one of a plastic material, an aluminum foil material, or a polymer material, that is, any material having flexibility can form the tube 1 of the present invention, and the material is highly reusable and low in cost, as described in the foregoing.

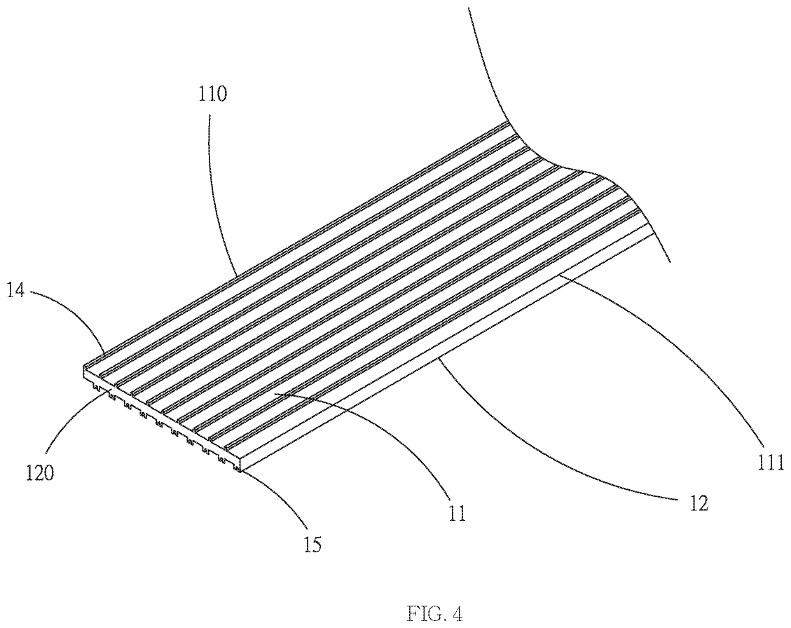

Additionally, referring to FIG. 4, which is an exploded view of a second embodiment of the environmentally-friendly straw improved structure of the present invention. It can be seen from the drawing that the greatest difference from the first embodiment lies in: a plurality of the joint portions 14 can be formed on the upper surface 11. Therefore, through the structural configuration of the joint portions 14, the user can snap and assemble the combination portion 15 correspondingly with any one of the joint portions 14 according to a required hole diameter of the tube 1. In this way, not only the combination simplicity can be greatly improved, but also a width of the hole diameter of the tube 1 can be adjusted at will, and thus the practicality is greatly increased.

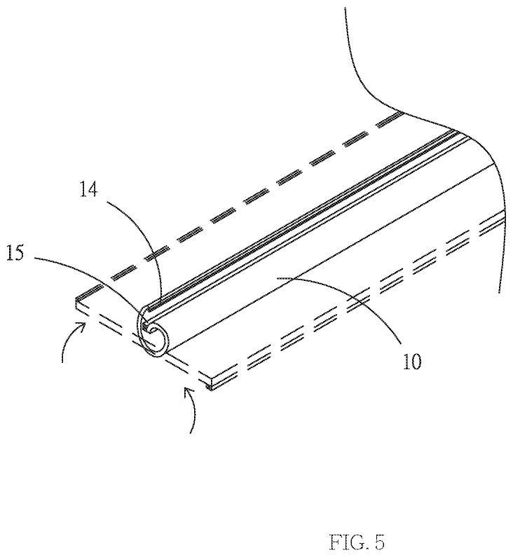

In addition, referring to FIG. 5, which is a perspective view of a third embodiment of the environmentally-friendly straw improved structure of the present invention, and the greatest difference from the first embodiment lies in: the combination portion 15 is snapped and assembled with the joint portion 14 from the foremost end of the tube 1, that is to say, the cross-sectional area of the two ends of the tube 1 is horizontal and not beveled, and the effects of the present invention can also be achieved.

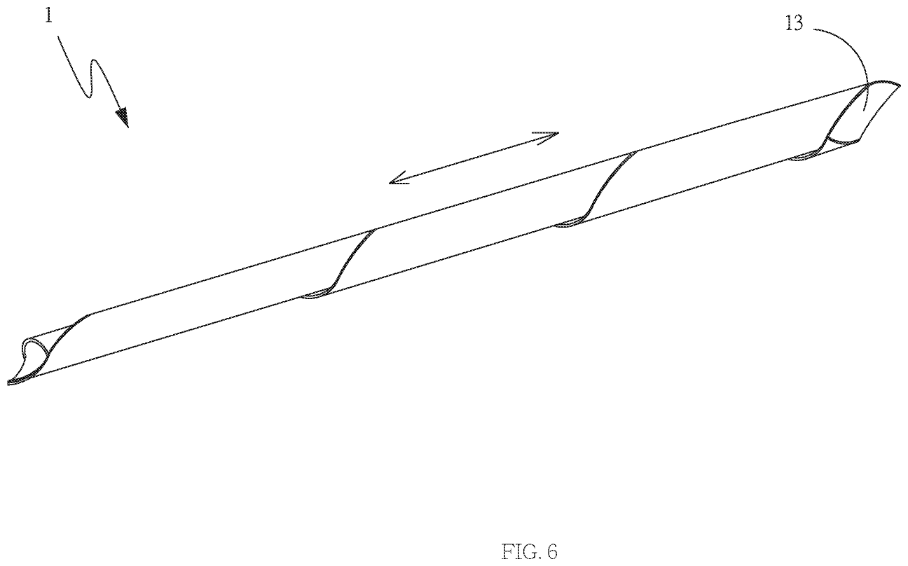

Please refer to FIG. 6 as well, which is a schematic view of the implementation of the first embodiment of the environmentally-friendly straw improved structure of the present invention. With the design of the structure of the present invention, the joint portion 14 formed at the first side edge 110 of the upper surface 11 and the combination portion 15 formed at the fourth side edge 121 of the lower surface 12 can be assembled and fastened with each other, and according to the requirement of use, the user can select to have the joint portion 14 snapped and assembled with the combination portion 15 from the foremost end of the tube 1, or to have joint portion 14 spaced apart from the foremost end of the tube 1 by a distance and then fastened and assembled with the combination portion 15, both the combinations can cause the original sheet-like flexible member 10 to be curled to form the tube 1. Thus, the user can use the tube 1 to suck the fluid (the fluid refers to beverages, tapioca balls, pearls, coconut jelly, etc.), and the straw is formed having the same function as that of general straws on the market. Moreover, when the tube 1 needs to be cleaned after use, it is only required to detach the joint portion 14 and the combination portion 15 to return the tube 1 to the sheet-like flexible member 10, and then directly wash and clean the flexible member 10 with water to have the tube 1 thoroughly cleaned, thereby achieving the effect of preventing dirt from remaining in the tube 1.

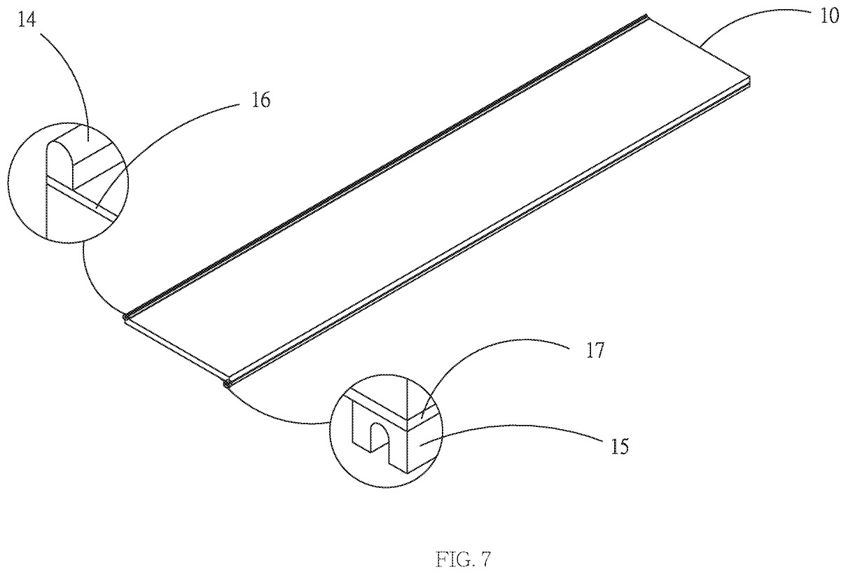

Finally, please refer to FIG. 7 as well as FIG. 1. FIG. 7 is an exploded view of a fourth embodiment of the environmentally-friendly straw improved structure of the present invention. The corresponding relationships between the components of the environmentally-friendly straw improved structure of this embodiment is the same as that of the aforementioned environmentally-friendly straw improved structure of the previous embodiments, and therefore will not be described herein again. However, the main differences between the environmentally-friendly straw improved structure of this embodiment and the foregoing lie in: the upper surface 11 is further formed with a first adhesive layer 16 corresponding to the first side edge 110, the lower surface 12 is further formed with a second adhesive layer 17 corresponding to the fourth side edge 121, and the second adhesive layer 17 is correspondingly attached to the first adhesive layer 16. With the disposition of the first and second adhesive layers 16, 17, the joint portion 14 and the combination portion 15 can be more secured when being assembled with each other, so that the sheet-like flexible member 10 is not easily uncurled itself, and the durability of the tube 1 is greatly increased.

As mentioned above, the present invention has the following advantages over the prior art:

1. reusable;

2. environmentally effective; and

3. thoroughly cleanable without residual dirt.

It is to be understood that the above description is only preferred embodiments of the present invention and is not used to limit the present invention, and changes in accordance with the concepts of the present invention may be made without departing from the spirit of the present invention, for example, the equivalent effects produced by various transformations, variations, modifications and applications made to the configurations or arrangements shall still fall within the scope covered by the appended claims of the present invention.

What is claimed is:

1. An environmentally-friendly straw improved structure, comprising:
a tube curlily formed by a sheet-like flexible member, the flexible member having an upper surface and a lower surface, a first side edge and a second side edge being respectively formed at two sides of the upper surface, a third side edge and a fourth side edge being respectively formed at two sides of the lower surface, and a hollow portion being correspondingly formed inside the tube;
at least one joint portion correspondingly formed at the first side edge of the upper surface; and
at least one combination portion correspondingly formed at the fourth side edge of the lower surface, and the combination portion being snapped with the joint portion to form the hollow portion for a fluid to pass through.

2. The environmentally-friendly straw improved structure as claimed in claim 1, wherein the joint portion is a rib.

3. The environmentally-friendly straw improved structure as claimed in claim 2, wherein the rib is formed in a continuous or discontinuous manner at the first side edge of the upper surface.

4. The environmentally-friendly straw improved structure as claimed in claim 1, wherein the combination portion is a groove.

5. The environmentally-friendly straw improved structure as claimed in claim 4, wherein the groove is formed in a continuous or discontinuous manner at the fourth side edge of the lower surface.

6. The environmentally-friendly straw improved structure as claimed in claim 1, wherein the sheet-like flexible member is made of any one of a plastic material, an aluminum foil material, or a polymer material.

7. The environmentally-friendly straw improved structure as claimed in claim 1, wherein the upper surface is further formed with a first adhesive layer corresponding to the first side edge, the lower surface is further formed with a second adhesive layer corresponding to the fourth side edge, and the second adhesive layer is correspondingly attached to the first adhesive layer.
